(19) United States
(12) Patent Application Publication
(10) Pub. No.: US 2026/0133335 A1
(43) Pub. Date: May 14, 2026

(54) METHODS FOR INTELLIGENTLY EXTRACTING SAND BODY CONFIGURATION BOUNDARY BASED ON SEISMIC DATA

(71) Applicant: SOUTHWEST PETROLEUM UNIVERSITY, Chengdu (CN)

(72) Inventors: Xiaoming ZHAO, Chengdu (CN); Yan ZHEN, Chengdu (CN); Wenjing RAN, Chengdu (CN); Jiawang GE, Chengdu (CN); Li LIU, Chengdu (CN); Kun QI, Chengdu (CN)

(73) Assignee: SOUTHWEST PETROLEUM UNIVERSITY, Chengdu (CN)

(21) Appl. No.: 19/294,350

(22) Filed: Aug. 8, 2025

(30) Foreign Application Priority Data
Nov. 8, 2024 (CN) 202411591606.7

(51) Int. Cl. G01V 1/50

(52) U.S. Cl. CPC G01V 1/50; G01V 2210/40

(57) ABSTRACT

A method for intelligently extracting a sand body configuration boundary based on seismic data is provided, including: collecting seismic data from a study region, obtaining seismic attribute prediction data of a sand body thickness in the study region; determining morphologically reconstructed attribute data by performing morphological reconstruction top-hat transformation on the seismic attribute prediction data; determining a discontinuous boundary of a sand body in the study region by performing a morphological gradient calculation on the morphologically reconstructed attribute data according to a designed morphological gradient operator; calculating a complexity parameter for the discontinuous boundary, quantitatively characterizing an irregularity degree of the discontinuous boundary, and determining a regional division count for each closed contour; and constructing an extension table by performing feature point filtering based on a curvature of an internal regional boundary, and identifying a sand body configuration boundary in the study region by performing closed contour matching.

### CROSS REFERENCE TO RELATED APPLICATIONS

This application claims priority to Chinese Patent Application No. 202411591606.7 filed on Nov. 8, 2024, the entire contents of which are incorporated herein by reference.

### TECHNICAL FIELD

The present disclosure relates to a field of geology, and in particular to a method for intelligently extracting a sand body configuration boundary based on seismic data.

### BACKGROUND

In the field of oil and gas exploration, the identification of lithological traps and discontinuous boundaries of sand bodies is crucial to finding subtle hydrocarbon reservoirs. Traditionally, seismic interpretation techniques and geological modeling and simulation are main means of identifying lithological traps and the discontinuous boundaries of the sand bodies. However, due to the limitations of seismic data resolution and the complexity of geological conditions, these methods often fail to achieve high accuracy and efficiency in identification. Particularly in sedimentary basins, a formation of the discontinuous boundaries of the sand bodies is affected by multiple factors, such as river channel migration, changes in sedimentary environments, and post-depositional diagenesis, which further increases the difficulty of identification.

In view of this, it is necessary to provide a method for intelligently extracting a sand body configuration boundary based on seismic data to more accurately capture the boundary information of the sand body and the features of the lithological traps.

### SUMMARY

One of the embodiments of the present disclosure provides a method for intelligently extracting a sand body configuration boundary based on seismic data. The method includes: collecting seismic data from a study region, and obtaining seismic attribute prediction data of a sand body thickness in the study region; determining morphologically reconstructed attribute data by performing morphological reconstruction top-hat transformation on the seismic attribute prediction data; determining a discontinuous boundary of a sand body in the study region by performing a morphological gradient calculation on the morphologically reconstructed attribute data according to a designed morphological gradient operator; calculating a complexity parameter for the discontinuous boundary, quantitatively characterizing an irregularity degree of the discontinuous boundary based on the complexity parameter, and determining a regional division count for each closed contour; and constructing an extension table by performing feature point filtering based on a curvature of an internal regional boundary, and identifying a sand body configuration boundary in the study region by performing closed contour matching.

The embodiments of the present disclosure include at least the following beneficial effects. (1) By combining various techniques such as morphological reconstruction, adaptive boundary detection, boundary complexity calculation, and fast randomized generalized Hough transform, the accuracy and efficiency of identification are improved. (2) By collecting and processing high-quality seismic data, it is possible to more accurately capture boundary information of sand bodies and features of lithological traps.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a flowchart of a method for intelligently extracting a sand body configuration boundary based on seismic data according to some embodiments of the present disclosure;

FIG. 2 is a raster grayscale diagram of seismic attribute prediction data of a sand body thickness in a study region according to some embodiments of the present disclosure;

FIG. 3 is a raster grayscale diagram of morphologically reconstructed attribute data according to some embodiments of the present disclosure;

FIG. 4 is a raster grayscale diagram of a discontinuous boundary of a sand body in a study region according to some embodiments of the present disclosure;

FIG. 5 is a frequency distribution histogram of a complexity parameter of a discontinuous boundary of a sand body in a study region according to some embodiments of the present disclosure;

FIG. 6 is a schematic diagram illustrating morphological gradient operators in 16 directions according to some embodiments of the present disclosure; and

FIG. 7 is a schematic diagram illustrating a detection result and a well point distribution of an irregular closed shape according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system,” “device,” “unit,” and/or “module” as used herein is a manner used to distinguish different components, elements, parts, sections, or assemblies at different levels. However, if other words serve the same purpose, the words may be replaced by other expressions.

As shown in the present disclosure and claims, the words “one,” “a,” “an,” and/or “the” are not especially singular but may include the plural unless the context expressly suggests otherwise. In general, the terms “comprise,” “comprises,” “comprising,” “include,” “includes,” and/or “including” merely prompt to include operations and elements that have been clearly identified, and these operations and elements do not constitute an exclusive listing. The methods or devices may also include other operations or elements.

The flowcharts used in the present disclosure illustrate operations that systems implement according to some embodiments of the present disclosure. It should be understood that the previous or subsequent operations may not be accurately implemented in order. Instead, each step may be processed in reverse order or simultaneously. Meanwhile, other operations may also be added to these processes, or a certain step or a plurality of steps may be removed from these processes.

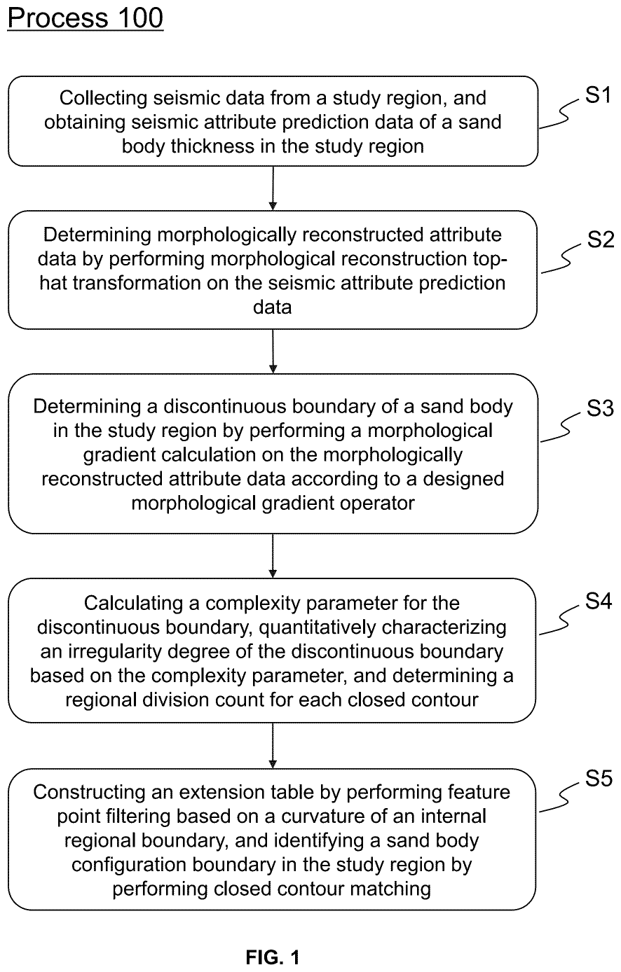

FIG. 1 is a flowchart of a method for intelligently extracting a sand body configuration boundary based on seismic data according to some embodiments of the present disclosure. As shown in FIG. 1, process 100 includes operations S1-S5. In some embodiments, the process 100 may be implemented by a processing device. The processing device may include a central processing unit (CPU), an application-specific integrated circuit (ASIC), an application-specific instruction set processor (ASIP), a graphics processing unit (GPU), a physics processing unit (PPU), a digital signal processor (DSP), a controller, a microcontroller unit, a reduced instruction set computer (RISC), a microcontroller, or the like, or any combination thereof.

S1, collecting seismic data from a study region, and obtaining seismic attribute prediction data of a sand body thickness in the study region.

The study region refers to a specific region for geological exploration, for example, a portion of a sedimentary basin where subtle hydrocarbon reservoirs may exist. In some embodiments, the study region may be determined by a geological survey, satellite remote sensing, a topographical survey, or the like.

The sand body thickness refers to a thickness of a sand body in a vertical direction. In some embodiments, the sand body thickness may be obtained by manners such as seismic inversion or attribute analysis.

The seismic attribute prediction data refers to a data volume that reflects underground lithology, physical properties, or fluid features, obtained by performing mathematical transformations and attribute extraction on original seismic data. The embodiments of the present disclosure do not place special limitations on the manners of mathematical transformation and attribute extraction, and operations well-known to those skilled in the art may be used.

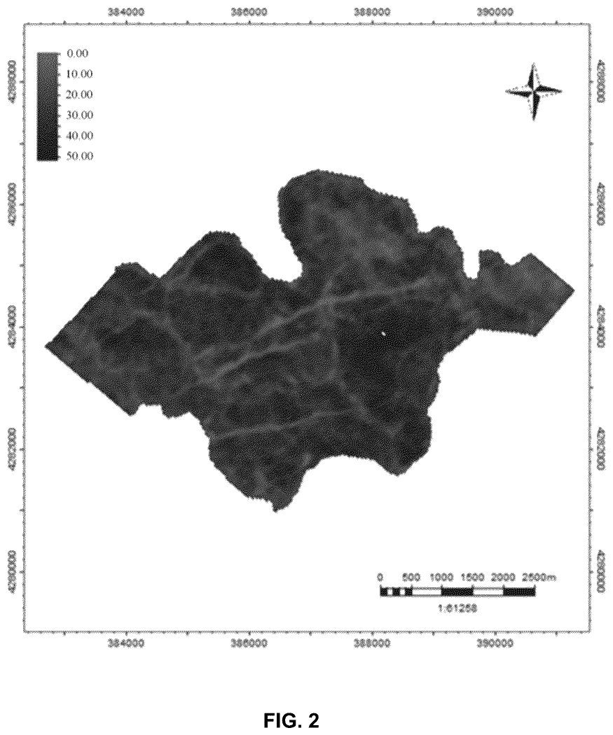

FIG. 2 is a raster grayscale diagram of seismic attribute prediction data of a sand body thickness in a study region according to some embodiments of the present disclosure. FIG. 2 presents spatial distribution features of a sand body thicknesses in original seismic attribute prediction data in the form of raster grayscale diagram. The grayscale gradient in the raster grayscale diagram represents the change in the sand body thickness. The brighter region indicates a greater sand body thickness, and the darker region reflect thinner sand bodies or mudstone regions. The numbers on the border represent geographical coordinates of the study region, and the color bar represents a change range of attribute values.

S2, determining morphologically reconstructed attribute data by performing morphological reconstruction top-hat transformation on the seismic attribute prediction data.

The morphologically reconstructed attribute data refers to a new type of data volume obtained after processing the seismic attribute prediction data through the mathematical morphological reconstruction top-hat transformation.

The seismic attribute prediction data refers to data related to seismic attributes, for example, the sand body thickness, sand body porosity, and so on.

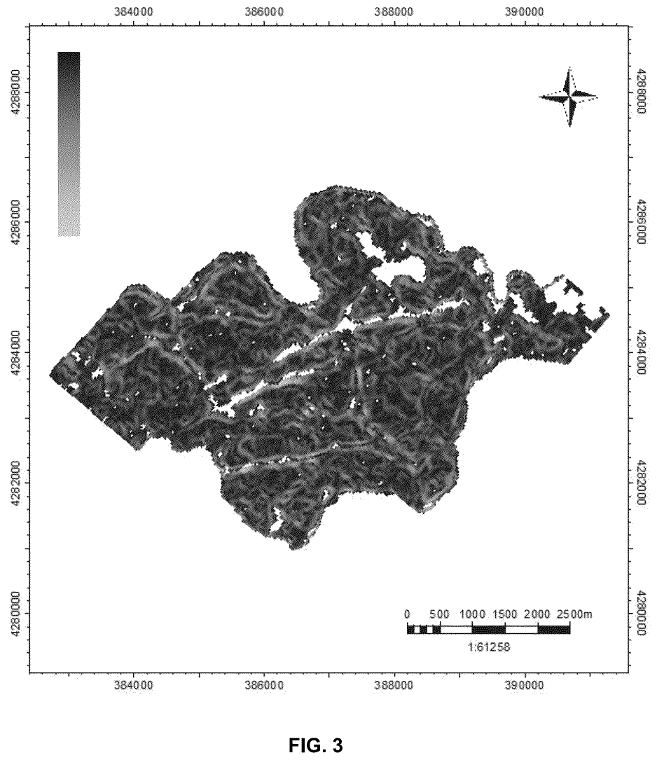

FIG. 3 is a raster grayscale diagram of morphologically reconstructed attribute data according to some embodiments of the present disclosure FIG. 3 presents spatial distribution features of the sand body thickness in the morphologically reconstructed attribute data in the form of raster grayscale diagram. The numbers on the border represent geographical coordinates of the study region, and the color bar represents the change range of attribute values. White regions are the regions where lithological changes are prominent after morphological reconstruction, the grayscale gradient represents the change in the sand body thickness, the dark regions are thick sand regions, and the light or gray regions represent thinner sand bodies or mudstone regions.

In some embodiments, the processing device may obtain an opening operation result by processing the seismic attribute prediction data using a morphological opening operation; obtain a top-hat transformation result by subtracting the opening operation result from the seismic attribute prediction data, and acquire marker data by comparing the top-hat transformation result with the seismic attribute prediction data using a minimum operation; determine reconstructed data by performing a morphological dilation operation on the marker data, if the marker data is not equal to the reconstructed data, continue an iterative morphological dilation operation until the marker data is equal to the reconstructed data; and determine a reconstruction result by subtracting the reconstructed data from the seismic attribute prediction data.

The top-hat transformation result refers to a result obtained by subtracting the opening operation result from the seismic attribute prediction data.

The minimum operation refers to an operation of taking a minimum value (a pixel value or an attribute value) at corresponding locations in two datasets during image processing. In the morphological reconstruction top-hat transformation, the minimum operation is used to compare the top-hat transformation result with the seismic attribute prediction data to obtain the marker data.

The morphological dilation operation is mainly used for expansion of the marker data in the morphological reconstruction process.

In some embodiments, the morphological dilation operation is performed on the marker data to obtain the reconstructed data, and if the marker data is not equal to the reconstructed data, the morphological dilation operation is iterated until the marker data is equal to the reconstructed data.

The reconstructed data refers to a result obtained after performing at least one morphological dilation operation on the marker data.

In some embodiments, the reconstruction result is obtained by subtracting the reconstructed data from the seismic attribute prediction data.

The reconstruction result is the morphologically reconstructed attribute data.

S3, determining a discontinuous boundary of the sand body in the study region by performing the morphological gradient calculation on the morphologically reconstructed attribute data according to a designed morphological gradient operator.

The morphological gradient operator (also known as a gradient operator or an operator) is an operator for calculating changes in image gradients based on morphology.

The morphological gradient calculation refers to a process of detecting image edges using the morphological gradient operator to extract regions with abrupt changes in pixel values in the image, such as the discontinuous boundary of the sand body.

The discontinuous boundary refers to a discontinuous region on the boundary of the sand body, for example, a location where the sand body thickness changes abruptly. The discontinuous boundary refers to an abrupt contact surface within the sand body or between the sand body and the surrounding rock. The discontinuous boundary reflects the abrupt change in lithological and physical features caused by sedimentary processes or later alterations.

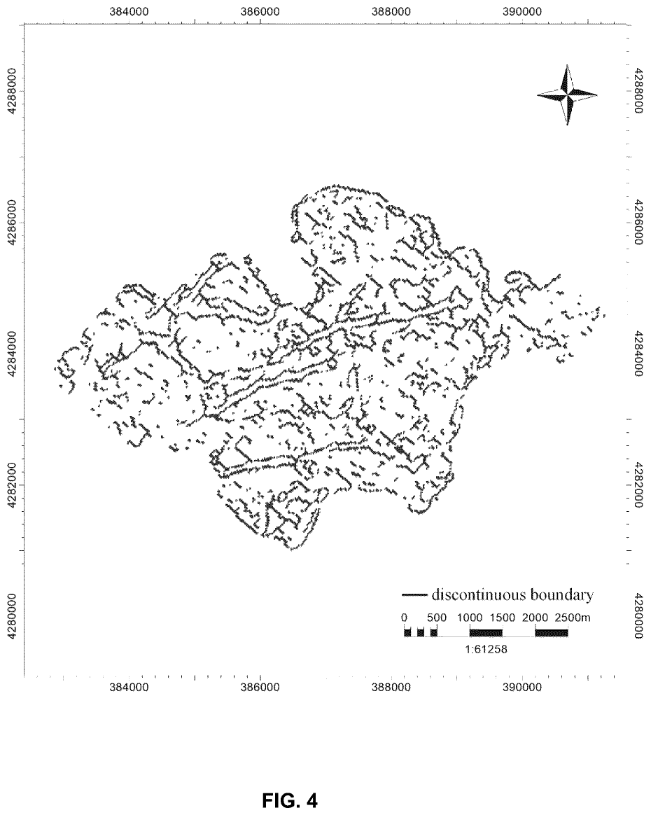

FIG. 4 is a raster grayscale diagram of a discontinuous boundary of a sand body in a study region according to some embodiments of the present disclosure. As shown in FIG. 4, the lines represent extracted lateral discontinuous boundaries of the sand body configuration, and the numbers on the border represent the coordinates of the study region.

In some embodiments, the processing device may design one or more morphological gradient operators in one or more specific directions; and accurately identify and extract the discontinuous boundary of the sand body in the study region based on the one or more morphological gradient operators in the one or more specific directions according to the morphologically reconstructed attribute data.

The specific direction includes a possible trend of the discontinuous boundary of the sand body.

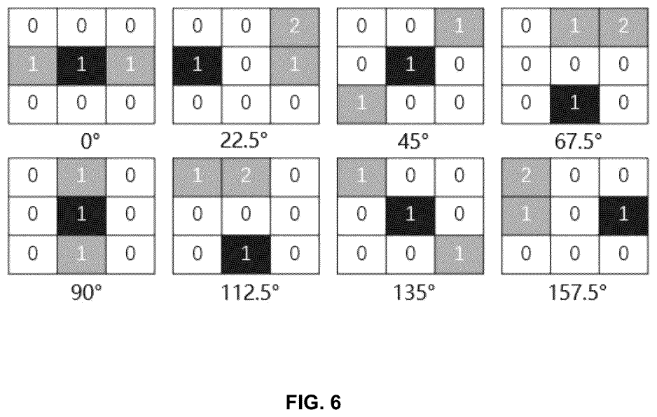

FIG. 6 is a schematic diagram illustrating morphological gradient operators in 16 directions according to some embodiments of the present disclosure.

In some embodiments, as shown in FIG. 6, the morphological gradient operators in specific directions may include:

0°, 180°, 22.5°, 202.5°, 45°, 225°, 67.5°, 247.5°, 90°, 270°, 112.5°, 292.5°, 135°, 315°, 157.5°, and 337.5°; where 22.5°, 67.5°, 112.5°, 157.5° and their corresponding opposite directions are morphological gradient operators in extended directions, and the other morphological gradient operators correspond to gradient changes in additional eight directions, thereby more effectively extracting information on the discontinuous boundary.

According to trigonometric calculations, it is known that the tangent value of 22.5° is tan 22.5°=\sqrt{2}−1, so the weight design of the morphological gradient operators is adjusted based on an influence of pixel values in different directions on gradient calculation location, as shown in the morphological gradient operators in the directions of 22.5°, 67.5°, 112.5°, and 157.5° in FIG. 6.

In some embodiments, the processing device may use an adaptive boundary detection algorithm to extract the discontinuous boundary of the sand body in the study region.

In some embodiments, the adaptive boundary detection algorithm is as follows: define w₁, w₂, w₃, w₄, w₅, w₆, w₇, w₈ as weights of directions of 0°, 22.5°, 45°, 67.5°, 90°, 112.5°, 135°, 157.5°, respectively; defining the weights as

$${w}_{i} = \frac{{D}_{i}}{D} ,$$

where wᵢ is the weight for each direction, Dᵢ is an magnitude for each direction, and D is a magnitude sum for all directions; assign the calculated weights to the detection boundaries in the corresponding directions to obtain an adaptive boundary detection algorithm for the discontinuous boundary of horizon attribute as

$${E}_{DAMG} = {\sum }_{k = 1}^{8} {w}_{k} {E}_{k} .$$

$${E}_{k} ( x , y ) = [ f \cdot {b}_{1} ∘ {b}_{2} ] ⊕ {b}_{3 k} ( x , y ) - [ f \cdot {b}_{1} ∘ {b}_{2} ] ⊖ {b}_{3 k} ( x , y ) , k = 1 , 2 , 3 ;$$

where b₁ denotes a cross-shaped structural element; b₂ denotes a rectangular structural element; and b₃ₖ denotes structural elements in different directions.

S4, calculating a complexity parameter for the discontinuous boundary, quantitatively characterizing an irregularity degree of the discontinuous boundary based on the complexity parameter, and determining a regional division count for each closed contour.

The irregularity degree refers to a degree of irregularity of the geometric shape of the discontinuous boundary. For example, a discontinuous boundary with a more regular geometric shape (such as a rectangle) corresponds to a lower irregularity degree; while a discontinuous boundary with a more complex geometric shape corresponds to a higher irregularity degree.

The closed contour refers to a contour of a closed region enclosed by the discontinuous boundary. The closed contour may represent a complete sand body or lithological trap.

The regional division count is a count used to divide the discontinuous boundary.

In some embodiments, the regional division count may be determined based on the area of the closed contour. For example, a threshold is determined based on manual experience, and the regional division count is set as a multiple by which the area of the closed contour exceeds the threshold.

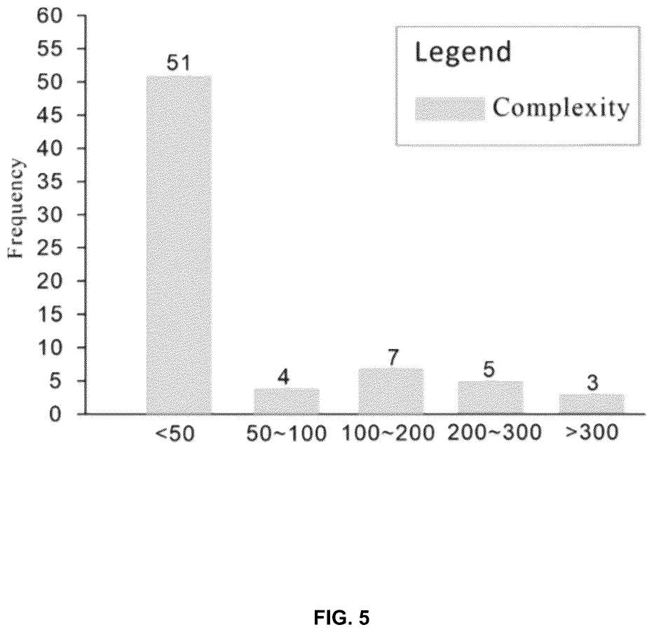

The complexity parameter is a parameter used to indicate the irregularity degree of the boundary of the sand body. FIG. 5 is a frequency distribution histogram of a complexity parameter of a discontinuous boundary of a sand body in a study region according to some embodiments of the present disclosure. As shown in FIG. 5, the horizontal axis represents the complexity distribution range, and the vertical axis represents the frequency of occurrence of the corresponding complexity.

In some embodiments, the processing device may determine the complexity parameter of the discontinuous boundary based on the perimeter and area of the minimum circumscribed rectangle of the discontinuous boundary, and the perimeter and area of the discontinuous boundary. In some embodiments, the formula for calculating the boundary complexity of the boundary contour for each discontinuous boundary is:

$$C = \frac{{L}_{R}}{{L}_{E}} \cdot \frac{{A}_{E}}{{A}_{R}}$$

where C represents the boundary complexity of the boundary contour; L_{R}, L_{E} represent the perimeter of the minimum circumscribed rectangle and the perimeter of the discontinuous boundary, respectively; A_{E}, A_{R} denote the area of the discontinuous boundary and the area of the minimum circumscribed rectangle, respectively. The closer C is to 1, the more regular the boundary contour is, and the lower the boundary complexity of the boundary contour is.

In some embodiments, a correspondence between the complexity parameter and the irregularity degree of the discontinuous boundary may be preset to quantitatively characterize the irregularity degree of the discontinuous boundary using the complexity parameter. For example, the correspondence between the complexity parameter and the irregularity degree of the discontinuous boundary may be a multiple relationship, etc.

In some embodiments, the processing device may determine the regional division count for the discontinuous boundary based on the complexity distribution range to which the complexity parameter of the discontinuous boundary belongs. For example, the processing device may predetermine a correspondence between different complexity distribution range and different regional division counts.

S5, constructing an extension table by performing feature point filtering based on a curvature of an internal regional boundary, and identifying the sand body configuration boundary in the study region by performing closed contour matching.

The internal regional boundary refers to an internal boundary of the region corresponding to the discontinuous boundary.

The feature point refers to a point with a special feature on the internal regional boundary, such as a high-curvature feature point, a corner point, etc.

In some embodiments, the extension table includes the location and the direction of the feature point and the complexity parameter of the discontinuous boundary where the feature point is located.

The sand body configuration boundary indicates a geometric shape and boundary features of a sand body in a spatial distribution, which is a closed contour composed of a plurality of discontinuous boundaries.

In some embodiments, the processing device may divide the internal regional boundary into a plurality of regions and select high-curvature feature points (e.g., feature points with a curvature higher than a curvature threshold) in each region to construct a fast randomized generalized Hough transform extension table (hereinafter referred to as the extension table).

The curvature threshold is a threshold used to screen the high-curvature feature points. When the curvature of a point on the internal regional boundary is greater than the curvature threshold, the point is considered the high-curvature feature point. In some embodiments, the curvature threshold may be determined based on manual experience.

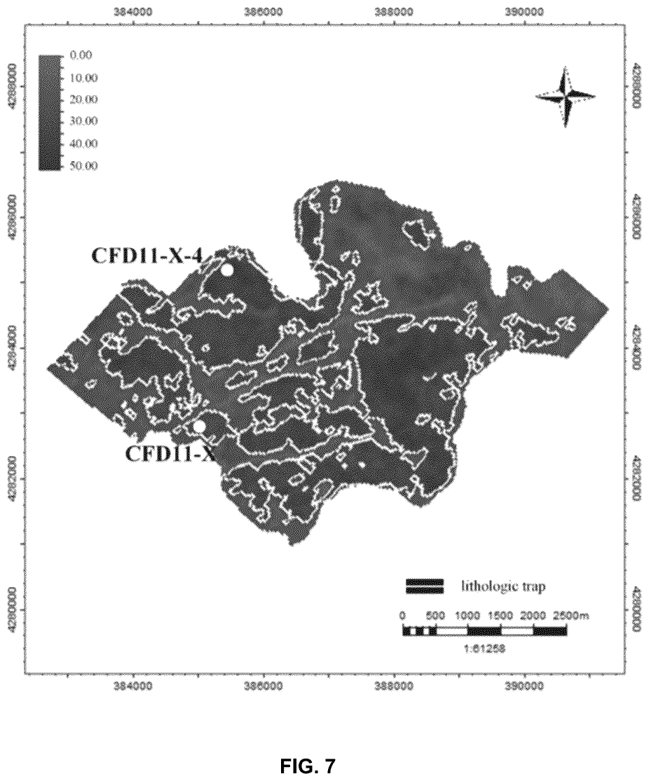

In some embodiments, the processing device may detect an irregular closed shape based on the constructed extension table and filter out a fragmented and non-closed boundary. FIG. 7 is a schematic diagram illustrating a detection result and a well point distribution of the irregular closed shape according to some embodiments of the present disclosure. As shown in FIG. 7, the white lines are the detected closed boundaries, the white dots are the locations of the well points, the text next to the well points represents the names of the well points, and the grayscale base map is the seismic attribute data.

The fragmented and non-closed boundary refers to a boundary in the extracted discontinuous boundary that is short in length and does not form the irregular closed shape.

In some embodiments, through the fast randomized generalized Hough transform, matching feature point combinations are searched for in different regions based on the extension table to deduce the shape of the closed contour, while filtering out the fragmented and non-closed boundaries, so as to detect the irregular closed shape (also known as the closed shape or the closed boundary).

In some embodiments, during an extension table creation process, selected points are ensured to originate from different regions, and the high-curvature feature point within each region are preferentially selected.

In some embodiments of the present disclosure, the closed contour matching is performed based on the irregular closed shapes detected by the improved fast randomized generalized Hough transform to identify the sand body configuration boundary in the study region. The improved fast randomized generalized Hough transform not only preserves the overall trend of the closed contour but also highlights local features, filters out the interference of small regions, and emphasizes large-scale lithological traps.

In some embodiments, the processing device may construct, in response to the sand body configuration boundary satisfying an update condition, a collection feature vector based on the sand body configuration boundary and the boundary complexity; determine a signal excitation parameter based on the collection feature vector and a first vector database; send the signal excitation parameter to a data collection device to control the data collection device to collect updated seismic data of the study region based on the signal excitation parameter; and determine an updated sand body configuration boundary based on the updated seismic data.

The update condition refers to a specific criterion or threshold that determines whether to re-collect the seismic data to update the sand body configuration boundary. In some embodiments, the update condition includes an effective region volume being greater than a volume threshold or an average of boundary complexities being greater than a complexity threshold. In some embodiments, the volume threshold and the complexity threshold may be empirical values, pre-set values, or any combination thereof, and may be set according to actual needs.

The effective region refers to a geological region enclosed by the sand body configuration boundary that has potential oil and gas resources. For example, assuming a long elliptical sand body configuration boundary with an area of about 10 square kilometers is identified in the study region, the geological structure within this elliptical range is considered an effective region having potential oil and gas resources.

In some embodiments, the effective region volume may be obtained based on the spatial volume in a three-dimensional geological space. For more details on the three-dimensional geological space, refer to the subsequent description in the present disclosure.

In some embodiments, the processing device may construct a collection feature vector based on the effective region volume, the average of the boundary complexities, and the sand body configuration boundary; retrieve in the first vector database based on the collection feature vector, and determine a reference signal excitation parameter corresponding to a reference collection feature vector with the highest similarity to the collection feature vector as the signal excitation parameter.

The first vector database includes a plurality of reference collection feature vectors and corresponding reference signal excitation parameters thereof. In some embodiments, the first vector database may be constructed in various ways. For example, the first vector database may be constructed based on historical data/experimental data from successful drillings. For example, from the historical/experimental data of successful drillings, the effective region volume, the average of the boundary complexities, and the sand body configuration boundary of historical sand bodies are extracted to construct a reference collection feature vector; and the signal excitation parameter used in the historical/experimental data of the successful drilling corresponding to the reference collection feature vector is taken as the reference signal excitation parameter corresponding to the reference collection feature vector. The historical data/experimental data of successful drillings refers to historical record data/experimental record data of successfully completed wellbore drilling and hydrocarbon reservoir collection.

The signal excitation parameter refers to a setup parameter for the data collection device when collecting the seismic data. In some embodiments, the signal excitation parameter may include a collection frequency (e.g., the frequency of collecting seismic data) and a collection precision. The collection precision may represent the ability of the seismic data to identify subsurface geological features. The collection precision may be represented by parameters such as the minimum identifiable geological body size (unit: meters), the energy ratio of the effective signal to noise (unit: dB), etc.

The data collection device is a device used to perform seismic data collection tasks. In some embodiments, the data collection device includes seismic source equipment for generating seismic waves and geophones for receiving the reflected seismic waves.

In some embodiments, after determining the signal excitation parameter, the processing device may send the signal excitation parameter to the data collection device. The data collection device resets its operating parameters according to the signal excitation parameter and re-collects the seismic data of the study region as the updated seismic data.

In some embodiments, the data collection device may set the energy output intensity and energy output frequency of the seismic source equipment, as well as the sensitivity of the geophones, according to the signal excitation parameter. For example, the data collection device may use the collection frequency in the signal excitation parameter as the energy output frequency of the seismic source equipment. As another example, the data collection device may set the energy output intensity of the seismic source equipment and the sensitivity of the geophones based on the positive correlation between the energy output intensity of the seismic source equipment and the collection precision in the signal excitation parameter, and the positive correlation between the sensitivity of the geophones and the collection precision.

After obtaining the updated seismic data, the processing device may determine the updated sand body configuration boundary based on the updated seismic data. The method for generating the updated sand body configuration boundary based on the updated seismic data is the same as the aforementioned method for intelligently extracting the sand body configuration boundary based on the seismic data, and will not be described again here.

The embodiments of the present disclosure achieve high-precision exploration of complex geological areas by dynamically adjusting seismic data collection parameters (such as the collection frequency and the collection precision), constructing the collection feature vector based on the sand body configuration boundary and its complexity, and using a vector database to retrieve an optimal signal excitation parameter. When the effective region volume or the boundary complexity of the study region exceeds a preset threshold, the system automatically triggers an update process, re-collecting the seismic data and updating the sand body configuration boundary. This manner not only improves the understanding and interpretation accuracy of subsurface geological structures and reduces the risk of dry wells, but also reduces costs and resource waste by drawing on the experience of historical successful cases, thereby significantly improving drilling success rates and project economic benefits.

In some embodiments, the processing device may also generate a wellbore coordinate within the effective region enclosed by the sand body configuration boundary, and send the wellbore coordinate to a rotary steerable system (RSS) to control a drill bit of a drilling platform to drill within the sand body configuration boundary.

The wellbore coordinate refers to a geographical coordinate of a specific drilling location designed for drilling operations within the effective region. In some embodiments, the wellbore coordinate is not limited to surface locations but also include specific coordinate points at different depths underground to guide the drill bit to accurately reach a target sand body to be drilled. In some embodiments, the wellbore coordinate may include coordinates of one or more wellbores, meaning a plurality of wellbores may be set within one effective region.

In some embodiments, the processing device may randomly select a location within the effective region as the wellbore coordinate.

In some embodiments, the processing device may divide the effective region into a plurality of small grids, where a side length of each grid is greater than or equal to a safety threshold, and then randomly select a point within each grid as the wellbore location to ensure that a plurality of wellbores may be distributed relatively evenly in the effective region. In some embodiments, a distance between two wellbores is at least the length of one grid (i.e., the safety threshold). In some embodiments, the safety threshold may be preset.

In some embodiments, the processing device may also construct a boundary graph based on the sand body configuration boundary, the boundary complexity, and the seismic data; and generate the wellbore coordinate based on the boundary graph.

The boundary graph refers to a knowledge graph used to describe the structured representation of the discontinuous boundary of the sand body in the study region. In some embodiments, the boundary graph consists of at least one node and at least one edge, where edges connect nodes, and nodes and edges have node features and edge features, respectively.

In some embodiments, each node of the boundary graph corresponds to each boundary point on the discontinuous boundary of the sand body in the study region. In some embodiments, the node features include the location of the corresponding boundary point in the three-dimensional geological space, the numerical value of the boundary point in the seismic attribute prediction data of the sand body thickness, and the seismic data within a preset range of the boundary point. In some embodiments, the preset range may be preset.

The three-dimensional geological space refers to a spatial model that represents subsurface geological structures, stratum distributions, ore body locations, and other information in the form of three-dimensional coordinates. In some embodiments, the three-dimensional geological space may be constructed based on the collected seismic data using modeling software (such as Petrel, GOCAD, Leapfrog, etc.).

In some embodiments, for each node in the boundary graph, edges may be established connecting the node to all other nodes that fall within a preset distance. The preset distance may be an empirical value, a pre-set value, or any combination thereof, and may be set according to actual needs. In some embodiments, the edge features include an actual physical distance between two nodes.

In some embodiments, the processing device may use a wellbore determination model to process the boundary map to obtain the wellbore coordinate. In some embodiments, the wellbore determination model is a machine learning model. For example, the wellbore determination model may be a Graph Neural Network (GNN) model.

In some embodiments, the processing device may input the boundary graph into the wellbore determination model, and the wellbore determination model outputs the wellbore coordinate.

The wellbore determination model may be obtained through model training based on at least one set of first training samples and a corresponding first label. In some embodiments, one set of the first training samples includes a sample boundary graph; the corresponding first label includes an annotated wellbore coordinate corresponding to the sample boundary graph.

In some embodiments, the processing device may perform the following training process to obtain the wellbore determination model. The training process includes: obtaining a plurality of first training samples with first labels to form a first training sample set, and performing a plurality of rounds of iteration based on the first training sample set. At least one round of iteration includes: selecting one or more first training samples from the first training dataset, inputting the one or more first training samples into an initial wellbore determination model to obtain model prediction outputs corresponding to the one or more first training samples; substituting the model prediction outputs corresponding to the one or more first training samples and the first labels corresponding to the one or more first training samples into a pre-defined loss function formula to calculate the value of the loss function; and iteratively updating model parameters in the initial wellbore determination model based on the value of the loss function until an iteration end condition is met, at which point the iteration ends, and a trained wellbore determination model is obtained. The model parameters of the initial wellbore determination model may be updated through various manners, for example, based on the gradient descent manner. The iteration end condition may include the convergence of the loss function or a count of iterations reaching an iteration count threshold.

In some embodiments, the process for constructing the sample boundary graph may include constructing a sample three-dimensional geological space based on historical data/experimental data from successful drillings, and extracting the boundary points on the discontinuous boundary of the sand body in the sample study region as sample nodes of the sample boundary graph; connecting the sample nodes with other sample nodes within the preset range to establish sample edges of the sample boundary graph; extracting the location of the boundary points corresponding to the sample nodes in the three-dimensional geological space, the seismic attribute prediction data, and the seismic data from the historical data/experimental data of successful drillings as sample node features; and extracting the physical distance between the sample nodes at both ends of the sample edge as sample edge features. In some embodiments, the wellbore coordinates actually recorded and used in the historical data/experimental data of successful drillings are used as the label corresponding to the sample boundary graph. The historical data/experimental data of successful drillings refers to historical record data/experimental record data of successfully completed wellbore drilling and hydrocarbon reservoir collection.

The embodiments of the present disclosure use the sand body configuration boundary, the seismic attribute prediction data, and the seismic data to provide a detailed geological information basis for the construction of the boundary graph, enabling the boundary graph to more comprehensively represent and simulate the complexity of subsurface geological structures. This allows the wellbore coordinates obtained by processing the boundary graph with advanced machine learning models like GNN to be accurately located within high-quality oil-bearing sand bodies, avoiding the huge economic losses caused by mistakenly drilling in non-oil-bearing areas. This manner can quickly adjust drilling strategies based on real-time data, adapt to changing geological conditions, and improve exploration efficiency and production benefits.

The rotary steerable system refers to a device configured to control operating parameters of a drill bit, such as a drilling speed, a drilling azimuth, a drilling location, etc. In some embodiments, the rotary steerable system may include devices and equipment such as an integrated electronic control unit (including a microprocessor and memory), a power and hydraulic unit (including a turbine generator, a hydraulic pump, and a battery pack), and a steering actuator (including one or more of hydraulic push pads and an internal universal joint/a deflectable drive shaft).

For a description of the drilling speed, the drilling azimuth, and the drilling location see the subsequent description in the present disclosure.

The drilling platform refers to a facility used for exploration and production operations of resources such as oil and natural gas. In some embodiments, the drilling platform may include, but is not limited to, land drilling platforms and offshore fixed drilling platforms. In some embodiments, the drilling platform may include a control system for controlling equipment such as the rotary steerable system, the data collection device, and a logging-while-drilling (LWD) collection device. In some embodiments, the control system may include calculating devices such as a processing device, a server, etc.

The drill bit is a tool configured to penetrate formations and create a wellbore. The drill bit is usually made of high-strength materials and can work in high-pressure and high-temperature environments, while requiring precise control of operating parameters to ensure it advances along a predetermined path.

In some embodiments, after generating the wellbore coordinate, the wellbore coordinate may be sent to the rotary steerable system through the control system of the drilling platform, and the rotary steerable system moves the drill bit to the location corresponding to the wellbore coordinate within the effective region and perform drilling.

The embodiments of the present disclosure, by using the sand body configuration boundary as a guide, can accurately position potential oil and gas resource locations, reduce a count of unnecessary drilling attempts, and avoid drilling dry wells without oil and gas, thereby significantly increasing the probability of finding hydrocarbon reservoirs. At the same time, the optimized wellbore layout can more efficiently extract oil and gas resources, improving the overall economic benefits of the project.

In some embodiments, while controlling the drill bit to drill within the sand body configuration boundary, the processing device may also use the logging-while-drilling collection device to monitor and obtain real-time seismic-while-drilling data of the study region; generate a safety distribution map based on the sand body configuration boundary, the boundary complexity, and the seismic-while-drilling data; determine drill bit control parameters based on the safety distribution map; and send the drill bit control parameters to the rotary steerable system to control the drill bit of the drilling platform to drill according to the drill bit control parameters.

In some embodiments, the logging-while-drilling collection device may include, but is not limited to, seismic-while-drilling sensors and downhole measurement tools.

The seismic-while-drilling data refers to real-time seismic waveform data collected by the logging-while-drilling collection device installed on a drill string (e.g., the drill bit) during the drilling process. In some embodiments, the seismic-while-drilling data may include seismic waveform data generated by the vibration of the drill bit (such as amplitude, frequency, and phase information of the seismic waves), location information of the drill bit in the well (including depth, coordinates, etc.), and a wellbore deviation and azimuth of the wellbore.

The wellbore deviation refers to an angle at which the wellbore trajectory deviates from the vertical direction. In some embodiments, the wellbore deviation may include an angle between a wellbore axis and a direction of gravity of Earth.

The safety distribution map refers to a risk assessment map constructed based on the sand body configuration boundary and its complexity. In some embodiments, the safety distribution map divides the study region into different risk level zones to guide the safe operation of the drill bit, ensuring that the drill bit drills in high-yield oil zones while avoiding high-risk zones. In some embodiments, the risk level zones in the safety distribution map may include a red warning zone, a yellow warning zone, and a green safe zone.

In some embodiments, the effective region within a first distance threshold from the sand body configuration boundary may be set as the red warning zone, the other effective regions within a second distance threshold from the sand body configuration boundary excluding the red warning zone may be set as the yellow warning zone, and the remaining region excluding the red warning zone and the yellow warning zone may be set as the green safe zone, where the first distance threshold is less than the second distance threshold.

In some embodiments, the first distance threshold and the second distance threshold may be preset. In some embodiments, the first distance threshold and the second distance threshold may be positively correlated with the boundary complexity, meaning that the greater the boundary complexity, the larger the red warning zone within the corresponding effective region of the boundary.

The drill bit control parameters are parameters used to guide the drilling platform to adjust the working state of the drill bit. In some embodiments, the drill bit control parameters may include the drilling speed and the drilling azimuth of the drill bit.

The drilling speed refers to a distance the drill bit advances downward or along the wellbore direction per unit of time (unit: m/s). For example, if a rig is operating in a relatively stable sandstone layer, a higher drilling speed, such as 30 meters/hour, may be selected; whereas when the drill bit of the rig approaches a complex geological structure region, the drilling speed may need to be reduced to 15 meters/hour or even lower to better respond to potential changes.

The drilling azimuth is an angle between the direction of the wellbore trajectory and a horizontal plane, i.e., a forward direction of the drill bit. In some embodiments, the drilling azimuth is usually measured relative to the geographic north direction. For example, if a target reservoir is in the northeast direction, the initial drilling azimuth may be set to 45 degrees (i.e., the northeast direction). As drilling deepens, this angle (45 degrees) may need to be fine-tuned based on real-time data feedback, such as adjusting it to 50 degrees, to ensure that the drill bit always follows the optimal path.

In some embodiments, the processing device may obtain the location information of the drill bit from the seismic-while-drilling data, and determine the drill bit control parameters based on the location information of the drill bit and the safety distribution map. For example, if the drill bit enters the red warning zone, drilling is immediately stopped (at this time, the drilling speed is set to 0), and manual intervention for inspection and adjustment is required. As another example, if the drill bit enters a yellow warning zone, the current drilling speed is reduced by a first preset magnitude and the current drilling azimuth is adjusted by a second preset magnitude in a direction away from the corresponding boundary of the yellow warning zone, thereby generating a new drilling speed and drilling azimuth, respectively. In some embodiments, the first preset magnitude and the second preset magnitude may be preset.

In some embodiments, the processing device may send the drilling speed and the drilling azimuth to the rotary steerable system via the control system, to control the rotary steerable system to set the operating parameters of the drill bit based on the drilling speed and the drilling azimuth.

The embodiments of the present disclosure, by monitoring the seismic-while-drilling data in real time, generating safety distribution features based on the sand body configuration boundary and the complexity of the boundary, and dynamically adjusting the drill bit control parameters (such as the drilling speed and he drilling azimuth) based on these features, achieve precise and safe control of the drilling process. This ensures that the drill bit advances along the optimal path, effectively improving the safety, precision, and work efficiency of drilling, while reducing the risk and cost of ineffective drilling.

In some embodiments, the processing device may also determine a predicted trajectory of the drill bit based on the sand body configuration boundary, the seismic-while-drilling data, the seismic attribute prediction data of the sand body thickness, the current drilling speed, and the current drilling azimuth; determine whether the predicted trajectory triggers a warning condition; and in response to the predicted trajectory triggering the warning condition, determine the drill bit control parameters based on the predicted trajectory and the safety distribution map.

The predicted trajectory refers to a predicted path of the drill bit as it performs a drilling work underground over a future preset time period. The preset time period may be preset. For example, assuming the current drill bit location is at a depth of 3000 meters, with a wellbore deviation of 3° and an azimuth of 45°, the predicted trajectory may be that in the next 10 minutes, the drill bit changes direction (e.g., adjusting the azimuth to) 50° while maintaining a lower drilling speed (e.g., reducing from 30 meters/hour to 15 meters/hour) to advance.

In some embodiments, the processing device may use a trajectory prediction model to process the seismic-while-drilling data, the sand body configuration boundary, the seismic attribute prediction data of the sand body thickness, the current drilling speed, and the current drilling azimuth to obtain the predicted trajectory.

In some embodiments, the trajectory prediction model may be a deep learning model, such as a Convolutional Neural Network (CNN), a Recurrent Neural Network (RNN), a Long Short-Term Memory (LSTM) network, etc.

In some embodiments, the processing device may input the seismic-while-drilling data, the sand body configuration boundary, the seismic attribute prediction data of the sand body thickness, the current drilling speed, and the current drilling azimuth into the trajectory prediction model, and the trajectory prediction model outputs the predicted trajectory of the drill bit.

The trajectory prediction model may be obtained through model training based on at least one set of second training samples and a corresponding second label. In some embodiments, one set of second training samples includes sample seismic-while-drilling data, a sample sand body configuration boundary, sample seismic attribute prediction data, a sample drilling speed, and a sample drilling azimuth; the corresponding second label includes an annotated predicted trajectory.

In some embodiments, the seismic-while-drilling data, the sand body configuration boundary, the seismic attribute prediction data of the sand body thickness, the drilling speed, and the drilling azimuth collected at or before a first historical time in historical data may be used as the sample seismic-while-drilling data, the sample sand body configuration boundary, the sample seismic attribute prediction data, the sample drilling speed, and the sample drilling azimuth in the second training sample; the actual trajectory of the drill bit collected at or after a second historical time in historical data may be used as the second label corresponding to the second training sample. The first historical time is chronologically before the second historical time.

The training process of the trajectory prediction model is similar to the training process of the aforementioned wellbore determination model and will not be described again here.

In some embodiments, an input to the trajectory prediction model also includes a drill bit feature. The drill bit feature refers to data related to the physical and mechanical properties of the drill bit. In some embodiments, the drill bit feature may include, but is not limited to, material composition and dimensional structure of the drill bit. In some embodiments, the dimensional structure of the drill bit may include a drill bit diameter and a drill bit type (such as a drag bit, a roller cone bit, a PDC bit, etc.).

In some embodiments, the processing device may obtain the drill bit feature from the drill bit manufacturer as the input to the trajectory prediction model. Correspondingly, the second training sample also include a sample drill bit feature.

The warning condition is a set of defined criteria or thresholds that, when the predicted trajectory of the drill bit approaches or meets these conditions, will trigger a warning in the system, prompting a need to adjust the drill bit control parameters to avoid potential risks. In some embodiments, the warning condition may include a boundary proximity warning condition and a center deviation warning condition. The boundary proximity warning condition is triggered when the predicted trajectory is about to enter the red warning zone or the yellow warning zone in the safety distribution map. The center deviation warning condition is triggered when, although the predicted trajectory is still within the sand body, it gradually deviates towards the edge or away from a target location. For example, if a horizontal distance between the drill bit and the target location exceeds a specific value (e.g., 50 meters), it is considered that the drill bit is starting to move away from the target location.

In some embodiments, when the predicted trajectory triggers the warning condition, the processing device may generate the drilling speed and the drilling azimuth based on preset rules.

In some embodiments, the preset rules may include adjusting the drilling azimuth by a third preset magnitude towards the target location when the center deviation warning condition is triggered. For example, if the current drilling azimuth is 45 degrees and the drill bit is deviating from the target, the drilling azimuth may be adjusted to 50 degrees to correct the path.

In some embodiments, the preset rules may include reducing the current drilling speed by a fourth preset magnitude and adjusting the current drilling azimuth by a fifth preset magnitude in a direction away from the boundary corresponding to the yellow warning zone when the boundary proximity warning condition is triggered and the predicted trajectory is about to enter the yellow warning zone. For example, assuming the current azimuth is 45 degrees and the drill bit is approaching the left boundary of the sand body at a speed of 30 meters/hour, to avoid the boundary, the drilling azimuth may be adjusted to 50 degrees to turn the drill bit to the right, and the drilling speed may be reduced from 30 meters/hour to 15 meters/hour to move away from the left boundary.

In some embodiments, the preset rules may include reducing the current drilling speed by a sixth preset magnitude and adjusting the current drilling azimuth by a seventh preset magnitude in a direction away from the boundary corresponding to the red warning zone when the boundary proximity warning condition is triggered and the predicted trajectory is about to enter the red warning zone.

In some embodiments, the third preset magnitude, the fourth preset magnitude, the fifth preset magnitude, the sixth preset magnitude, and the seventh preset magnitude can be preset, and the sixth preset magnitude is greater than the fourth preset magnitude, and the seventh preset magnitude is greater than the fifth preset magnitude.

In some embodiments, the drill bit control parameters also include a rotational speed of the drill bit, a pressure on the drill bit, and a drilling fluid flow rate, and the processing device may also determine the drill bit control parameters based on the current drill bit control parameters, the type of warning triggered, the trigger parameters, and the seismic-while-drilling data.

The rotational speed refers to a count of revolutions the drill bit makes per minute, usually expressed in revolutions per minute (RPM). It should be understood that the rotational speed affects the ability of the drill bit to cut rock, as well as the speed and efficiency of drilling.

The pressure on the drill bit refers to s vertical downward pressure applied to the drill bit, usually expressed in pounds-force (lbf) or kilonewtons (kN). It should be understood that appropriate pressure on the drill bit may ensure that the drill bit effectively cuts rock, but excessive pressure on the drill bit may lead to drill bit damage or sticking.

The drilling fluid flow rate refers to a volume of drilling fluid pumped into the wellbore per unit of time, usually expressed in liters per second (L/s) or gallons per minute (GPM). The main functions of the drilling fluid are to cool the drill bit, carry rock cuttings back to the surface, and stabilize the wellbore wall.

The type of warning triggered refers to a type of warning condition that is currently triggered. In some embodiments, the type of warning triggered may include the aforementioned boundary proximity warning condition and center deviation warning condition.

The trigger parameters refer to specific indicators or values that currently cause a warning to occur, i.e., the specific parameter basis for triggering different types of warning. For example, when the type of warning triggered is the boundary proximity warning condition, the trigger parameters may include the type of warning zone the predicted trajectory is entering (the red warning zone or the yellow warning zone), the distance between the current location of the drill bit and the nearest sand body configuration boundary, and the relative location of the drill bit with respect to that boundary (e.g., the boundary is to the left of the drill bit). As another example, when the type of warning triggered is the center deviation warning condition, the trigger parameters may include the current location of the drill bit and the target location.

In some embodiments, the processing device may construct a motion feature vector based on the current drill bit control parameters, the type of warning triggered, the trigger parameters, and the seismic-while-drilling data; retrieve in a second vector database based on the motion feature vector, and determine reference drill bit control parameters corresponding to a reference motion feature vector with the highest similarity to the motion feature vector as the drill bit control parameters.

The second vector database includes a plurality of sets of reference motion feature vectors and corresponding reference drill bit control parameters. In some embodiments, the second vector database may be constructed in various ways. For example, based on records of successfully executed adjustments in historical records, the drill bit control parameters before the adjustment, the type of warning triggered, the trigger parameters, and the seismic-while-drilling data may be extracted to construct the reference motion feature vector; and the drill bit control parameters used during this adjustment in the historical record corresponding to the reference motion feature vector are taken as the reference drill bit control parameters corresponding to the reference motion feature vector. The successfully executed adjustment in historical records refers to a record in history where, when a warning condition was triggered, the drill bit control parameters were adjusted, and no warning condition was triggered again for a period of time after the adjustment.

The embodiments of the present disclosure use historical data and successful cases stored in the second vector database to provide a scientific basis and technical guidance for the current adjustment of the drill bit control parameters (such as the pressure on the drill bit, the rotational speed, the drilling fluid flow rate, etc.). This not only improves the accuracy and reliability of decision-making and effectively prevents drilling accidents, but also allows for precise control of the drill bit trajectory, ensuring that drilling activities are concentrated in areas rich in oil and gas reserves, reducing ineffective drilling, and maximizing resource recovery rates.

The embodiments of the present disclosure, by integrating seismic-while-drilling (SWD) sensors, obtain real-time geological data ahead of the drill bit to generate the predicted trajectory and obtain the drilling speed and the drilling azimuth. By using the rotary steerable system to regulate the drilling speed and the drilling azimuth of the drill bit, it can accurately position the drill bit path. It utilizes various warning mechanisms (such as boundary proximity and center deviation) to ensure drilling safety and avoid potential risks, enabling the drill bit to operate efficiently even in complex geological conditions, maximizing reservoir utilization, and ensuring a smooth wellbore trajectory, thereby significantly improving the safety, precision, and resource extraction efficiency of drilling operations.

When describing the operations performed in the embodiments in the present disclosure by steps, an order of the steps may all be interchangeable, the steps may be omitted, and other steps may be included in the process of the operations if not otherwise specified.

The embodiments in the present disclosure are for the purpose of exemplification and illustration only, and do not limit the scope of application of the present disclosure. For those skilled in the art, various amendments and changes may be made under the guidance of the present disclosure, and these amendments and changes remain within the scope of the present disclosure.

Some features, structures, or features of one or more embodiments of the present disclosure may be suitably combined.

Aspects of the present disclosure may be performed entirely by hardware, entirely by software (including firmware, resident software, microcode, etc.), or by a combination of hardware and software. All of the above hardware or software may be referred to as a “block,” “module,” “engine,” “unit,” “component,” or “system. Additionally, aspects of the present disclosure may be manifested as a computer product disposed in one or more computer-readable mediums, the product including computer-readable program code.

Computer storage media may be any computer-readable medium used to communicate, disseminate, or transmit a program for use by connecting to an instruction execution system, device, or apparatus. The program code located on the computer storage medium may be disseminated via any suitable medium, including radio, cable, fiber optic cable, RF, etc., or a combination of any of the foregoing.

The computer program code required for the operation of the various sections of the present disclosure may be written in any one or more programming languages. The program code may be run entirely on the user's computer, or as a stand-alone software package on the user's computer, or partly on the user's computer and partly on a remote computer, or entirely on a remote computer or processing device. In the latter case, the remote computer may be connected to the user's computer through any form of network, such as a local region network (LAN) or wide region network (WAN), or connected to an external computer (e.g., via the Internet), or in a cloud calculating environment, or used as a service such as software as a service (SaaS).

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for intelligently extracting a sand body configuration boundary based on seismic data, comprising:
collecting seismic data from a study region, and obtaining seismic attribute prediction data of a sand body thickness in the study region;
determining morphologically reconstructed attribute data by performing morphological reconstruction top-hat transformation on the seismic attribute prediction data;
determining a discontinuous boundary of a sand body in the study region by performing a morphological gradient calculation on the morphologically reconstructed attribute data according to a designed morphological gradient operator;
calculating a complexity parameter for the discontinuous boundary, quantitatively characterizing an irregularity degree of the discontinuous boundary based on the complexity parameter, and determining a regional division count for each closed contour; and
constructing an extension table by performing feature point filtering based on a curvature of an internal regional boundary, and identifying a sand body configuration boundary in the study region by performing closed contour matching.

2. The method according to claim 1, wherein the determining the morphologically reconstructed attribute data by performing the morphological reconstruction top-hat transformation on the seismic attribute prediction data comprises:
obtaining an opening operation result by processing the seismic attribute prediction data using a morphological opening operation;
obtaining a top-hat transformation result by subtracting the opening operation result from the seismic attribute prediction data, and acquiring marker data by comparing the top-hat transformation result with the seismic attribute prediction data using a minimum operation;
determining reconstructed data by performing a morphological dilation operation on the marker data, if the marker data is not equal to the reconstructed data, continuing an iterative morphological dilation operation until the marker data is equal to the reconstructed data; and
determining a reconstruction result by subtracting the reconstructed data from the seismic attribute prediction data.

3. The method according to claim 1, wherein the determining the discontinuous boundary of the sand body in the study region by performing the morphological gradient calculation on the morphologically reconstructed attribute data according to the designed morphological gradient operator comprises:
designing one or more morphological gradient operators in one or more specific directions; and
accurately identifying and extracting the discontinuous boundary of the sand body in the study region based on the one or more morphological gradient operators in the one or more specific directions according to the morphologically reconstructed attribute data.

4. The method according to claim 3, wherein the one or more morphological gradient operators in the one or more specific directions includes:
morphological gradient operators in 16 directions including 0°, 180°, 22.5°, 202.5°, 45°, 225°, 67.5°, 247.5°, 90°, 270°, 112.5°, 292.5°, 135°, 315°, 157.5°, and 337.5°.

5. The method according to claim 1, wherein the calculating the complexity parameter for the discontinuous boundary comprises:
calculating a boundary complexity of a boundary contour for each discontinuous boundary; and
determining the regional division count for the discontinuous boundary based on a distribution range of the boundary complexity of the discontinuous boundary.

6. The method according to claim 5, wherein a formula for calculating the boundary complexity of the boundary contour for each discontinuous boundary is:
$$C = \frac{{L}_{R}}{{L}_{E}} \cdot \frac{{A}_{E}}{{A}_{R}}$$
where C denotes the boundary complexity of the boundary contour; L_{R} and L_{E} denote a perimeter of a minimum circumscribed rectangle and a perimeter of the discontinuous boundary, respectively; A_{E} and A_{R} denote an area of the discontinuous boundary and an area of the minimum circumscribed rectangle, respectively.

7. The method according to claim 1, wherein the constructing the extension table by performing the feature point filtering based on the curvature of the internal regional boundary, and identifying the sand body configuration boundary in the study region by performing closed contour matching comprises:
dividing the discontinuous boundary into a plurality of regions, and selecting a high-curvature feature point within each of the plurality of regions to construct the extension table based on fast randomized generalized Hough transform (FRGHT);
detecting an irregular closed shape based on the constructed extension table and filtering out fragmented and non-closed boundaries,
during a creation process of the extension table, ensuring that selected points come from different regions in the plurality of regions, and prioritizing selecting the high-curvature feature point within each region; and
identifying the sand body configuration boundary in the study region by performing the closed contour matching based on the irregular closed shape detected by the fast randomized generalized Hough transform.
